(19) United States
(12) Patent Application Publication
(10) Pub. No.: US 2025/0026922 A1
(43) Pub. Date: Jan. 23, 2025

(54) RECLAIMED RUBBER-CONTAINING RUBBER COMPOSITION AND PNEUMATIC TIRE

(71) Applicant: Toyo Tire Corporation, Itami-shi (JP)

(72) Inventor: Shuhei Yamamoto, Itami-shi (JP)

(73) Assignee: Toyo Tire Corporation, Itami-shi (JP)

(21) Appl. No.: 18/760,526

(22) Filed: Jul. 1, 2024

(30) Foreign Application Priority Data
Jul. 20, 2023 (JP) 2023-118151

(51) Int. Cl. C08L 9/00; B60C 1/00

(52) U.S. Cl. CPC C08L 9/00; B60C 1/00; C08L 2207/24

(57) ABSTRACT

A reclaimed rubber-containing rubber composition comprising a reclaimed rubber, wherein the reclaimed rubber allows a vulcanized rubber of a specific rubber composition for evaluation described below to have a rubber elastic modulus of 2.0 MPa or more as measured with an atomic force microscope:
rubber composition for evaluation; a rubber composition containing 20 parts by mass of the reclaimed rubber per 100 parts by mass of isoprene rubber and not containing carbon black. The rubber composition for evaluation preferably contains 1.5 parts by mass of sulfur per 100 parts by mass of isoprene rubber. The reclaimed rubber-containing rubber composition preferably contains 1 to 10 parts by mass of the reclaimed rubber when a total amount of a rubber component is taken as 100 parts by mass.

### BACKGROUND OF THE INVENTION

### Field of the Invention

The present invention relates to a reclaimed rubber-containing rubber composition and a pneumatic tire including a rubber part obtained by vulcanizing and molding the reclaimed rubber-containing rubber composition.

### Description of the Related Art

In recent years, there has been a strong demand for the reuse of vulcanized rubber waste materials generated from used tires and other rubber products due to an increase in environmental awareness.

Patent Document 1 mentioned below discloses a reclaimed rubber-containing rubber composition containing a reclaimed rubber obtained by further subjecting a rubber powder prepared by micronization so as to contain 25% or more of particles passing through a 145-mesh screen to oil pan processing.

### PRIOR ART DOCUMENT

### Patent Document

Patent Document 1: JP-A-2004-35663

### SUMMARY OF THE INVENTION

The present inventors have intensively studied and found that a vulcanized rubber of the reclaimed rubber-containing rubber composition obtained by the conventional art described above has room for improvement in fracture characteristics and fatigue resistance.

In light of the foregoing, it is an object of the present invention to provide a reclaimed rubber-containing rubber composition capable of providing a vulcanized rubber excellent in fracture characteristics and fatigue resistance and a pneumatic tire including a rubber part obtained by vulcanizing and molding the reclaimed rubber-containing rubber composition.

The above object can be achieved by the following configurations. Specifically, the present invention relates to a reclaimed rubber-containing rubber composition (1) containing a reclaimed rubber, wherein the reclaimed rubber allows a vulcanized rubber of a specific rubber composition for evaluation described below to have a rubber elastic modulus of 2.0 MPa or more as measured with an atomic force microscope:
rubber composition for evaluation; a rubber composition containing 20 parts by mass of the reclaimed rubber per 100 parts by mass of isoprene rubber and not containing carbon black.

The reclaimed rubber-containing rubber composition (1) is preferably a reclaimed rubber-containing rubber composition (2), wherein the rubber composition for evaluation contains 1.5 parts by mass of sulfur per 100 parts by mass of isoprene rubber.

The reclaimed rubber-containing rubber composition (1) or (2) is preferably a reclaimed rubber-containing rubber composition (3) which contains 1 to 10 parts by mass of the reclaimed rubber when a total amount of a rubber component is taken as 100 parts by mass.

Any one of the reclaimed rubber-containing rubber compositions (1) to (3) is preferably a reclaimed rubber-containing rubber composition (4), wherein the reclaimed rubber is derived from a tire tread.

Any one of the reclaimed rubber-containing rubber compositions (1) to (4) is preferably a reclaimed rubber-containing rubber composition (5), wherein the reclaimed rubber contains 50 parts by mass or more of at least one selected from the group consisting of natural rubber and isoprene rubber when a total amount of a rubber component is taken as 100 parts by mass.

The present invention also relates to a pneumatic tire (6) including a rubber part obtained by vulcanizing and molding any one of the reclaimed rubber-containing rubber compositions (1) to (5).

The reclaimed rubber-containing rubber composition according to the present invention contains a specific reclaimed rubber, specifically a reclaimed rubber that allows a vulcanized rubber of a specific rubber composition for evaluation described below to have a rubber elastic modulus of 2.0 MPa or more as measured with an atomic force microscope:
rubber composition for evaluation; a rubber composition containing 20 parts by mass of the reclaimed rubber per 100 parts by mass of isoprene rubber and not containing carbon black.

An atomic force microscope (hereinafter also simply referred to as “AFM”) is a microscope of a type that detects an atomic force acting between a probe and a sample, and is synonymous with SPM in a broad sense. An AFM probe is attached to the tip of a cantilever spring (cantilever), and various physical properties can be measured by changing the type of cantilever and the method of signal detection. Distance dependency of force acting between a probe and a sample in AFM is the most basic measured quantity and is called a force curve. The force curve is obtained by plotting the displacement of a piezoelectric device that controls the distance between the probe and the sample on the horizontal axis and plotting the displacement of the cantilever on the vertical axis. When the spring constant k of the cantilever is previously known, the displacement can be converted into force (N). When the probe and the sample come close to each other and finally come into contact with each other, a repulsive force works and increases as indentation increases. When the sample is softer than the spring constant of the cantilever as in the case of a vulcanized rubber, the surface of the sample is deformed by indentation with the probe. Therefore, the displacement of the cantilever and the displacement of the piezoelectric element are not coincident with each other so that the force curve becomes non-linear. From such a relationship, the local elastic modulus of the sample can be evaluated. It should be noted that in order to calculate the quantitative value of elastic modulus, it is necessary to know the area of contact between the probe and the surface of the sample, but it is practically impossible to actually measure it. Therefore, a theoretical calculation expression of a contact model obtained by assuming that the tip of the probe has a spherical shape is usually fitted to the force curve, and an elastic modulus is obtained from fitting parameters thereof.

The present inventors measured a vulcanized rubber of a rubber composition for evaluation containing 20 parts by mass of a reclaimed rubber per 100 parts by mass of isoprene rubber and not containing carbon black with an AFM. The present inventors have found that when a reclaimed rubber that increases the rubber elastic modulus of a vulcanized rubber of the rubber composition for evaluation to 2.0 MPa or more is added to an unvulcanized rubber (new rubber), the fracture characteristics and fatigue resistance of a vulcanized rubber can be maintained and improved. The reason why such an effect is produced is not clear, but it is considered that when the reclaimed rubber is added to a new rubber, the dispersibility of the reclaimed rubber is improved due to an enhanced compatibilizing effect so that an excellent reinforcing effect is obtained, and therefore as compared to when a general reclaimed rubber is added, the adverse effect of reclaimed rubber on fracture characteristics and fatigue resistance can more significantly be reduced. Further, the reclaimed rubber is preferably derived from a tire tread, and particularly the reclaimed rubber preferably contains 50 parts by mass or more of at least one selected from the group consisting of natural rubber and isoprene rubber when a total amount of a rubber component is taken as 100 parts by mass because the rupture strength of vulcanized rubber of the reclaimed rubber-containing rubber composition is improved.

The reclaimed rubber-containing rubber composition according to the present invention is capable of providing a vulcanized rubber excellent in fracture characteristics and fatigue resistance. Therefore, the reclaimed rubber-containing rubber composition is useful as a rubber composition for pneumatic tires, especially a rubber composition for pneumatic tire treads.

### DETAILED DESCRIPTION OF THE PREFERRED EMBODIMENTS

A reclaimed rubber-containing rubber composition according to the present invention contains a reclaimed rubber. Hereinbelow, the reclaimed rubber will be described.

Reclaimed rubber is generally produced by pulverizing waste rubber such as waste tires and devulcanizing it. The waste tires include various members such as treads and side walls constituting the tires. In the present invention, from the viewpoint of improving the rupture strength of vulcanized rubber of the reclaimed rubber-containing rubber composition, the reclaimed rubber is preferably derived from a tire tread. An example of such a reclaimed rubber derived from a tire tread includes a reclaimed rubber produced using, as a raw material, waste rubber obtained by buffing away treads when retreaded tires are produced.

In the present invention, from the viewpoint of improving the rupture strength of vulcanized rubber of the reclaimed rubber-containing rubber composition, the reclaimed rubber preferably contains 50 parts by mass or more, more preferably 70 parts by mass or more of at least one selected from the group consisting of natural rubber and isoprene rubber when the total amount of a rubber component is taken as 100 parts by mass.

The reclaimed rubber contained in the reclaimed rubber-containing rubber composition according to the present invention can be produced by using as a raw material, for example, tire tread members of truck and bus tires having a high natural rubber content. Specifically, the reclaimed rubber can be produced using, as a material, a rubber powder obtained by micronizing such tire tread members to obtain particles having a maximum diameter of 500 μm and further collecting particles having a maximum diameter of 150 μm with an air classifier.

The thus obtained rubber powder is preferably further subjected to oil pan processing. The processing is performed by, for example, charging the micronized rubber powder into an autoclave, adding a reclaiming agent, and subjecting a resultant to a devulcanization reaction at a temperature of about 200° C. for 3 to 6 hours in a steam atmosphere. Examples of the reclaiming agent to be used include those known to those skilled in the art, such as thiophenol and n-butylamine.

The reclaimed rubber contained in the reclaimed rubber-containing rubber composition according to the present invention is produced by, for example, the above-described method and has the following characteristics.

When the reclaimed rubber is added to obtain a specific rubber composition for evaluation described below, a vulcanized rubber of the rubber composition for evaluation has a rubber elastic modulus of 2.0 MPa or more as measured with an atomic force microscope:
rubber composition for evaluation; a rubber composition containing 20 parts by mass of the reclaimed rubber per 100 parts by mass of isoprene rubber and not containing carbon black.

It should be noted that the rubber composition for evaluation used in the present invention does not contain carbon black because it is difficult, when carbon black is contained in the rubber composition for evaluation, to determine an increase or decrease in AFM elastic modulus image caused by adding the reclaimed rubber.

The rubber composition for evaluation is preferably a rubber composition for evaluation (1) containing 1.5 parts by mass of sulfur with respect to 100 parts by mass of isoprene rubber, particularly preferably a rubber composition for evaluation (2) having the following formulation.

### (Rubber Composition for Evaluation (2))

“Isoprene rubber (Mooney viscosity (ML(1+4) 75.0-90.0) trade name “Nipol@IR2200”, manufactured by Zeon Corporation” 100 parts by mass
“Reclaimed rubber” 20 parts by mass
“Stearic acid: trade name “LUNAC S-20”, manufactured by Kao Corporation” 2 parts by mass
“Zinc white: trade name “Zinc White #1”, manufactured by Mitsui Mining & Smelting Corporation” 2 parts by mass
“Vulcanization accelerator: trade name “NOCCELER NS”, manufactured by OUCHI SHINKO CHEMICAL INDUSTRIAL CO., LTD.” 1.5 parts by mass
Sulfur: trade name “Powdered sulfur for rubber, 150 mesh” manufactured by Hosoi Chemical Industry Co., Ltd.” 1.5 parts by mass

In the present invention, the rubber elastic modulus of the vulcanized rubber as measured with an atomic force microscope is an average elastic modulus determined by scanning a matrix area of a 5-μm square with 128 pixels×128 pixels. The rubber elastic modulus of the vulcanized rubber as measured with an atomic force microscope is 2.0 MPa or more, more preferably 2.5 MPa or more. The upper limit of the rubber elastic modulus is not limited, but is, for example, about 5.0 MPa.

The reclaimed rubber used in the present invention preferably contains carbon black having a specific surface area based on BET method of 100 to 120 m²/g. Such carbon black having a large specific surface area is preferred because when the reclaimed rubber is added to a new rubber that has not yet been vulcanized, the carbon black has the effect of enhancing reinforcing properties.

The reclaimed rubber used in the present invention is preferably designed to have a gel fraction of 75% or less. This makes it possible, when the reclaimed rubber is added to a new rubber that has not yet been vulcanized, to enhance a compatibilizing effect, thereby improving the dispersibility of the reclaimed rubber.

The reclaimed rubber used in the present invention preferably has an average particle diameter d70 of 100 μm or less and an average particle diameter d90 of 150 μm or less. This makes it possible to further preferably reduce the gel fraction of the reclaimed rubber because a large amount of a polymer is eluted when devulcanization is performed. It should be noted that a method for measuring the particle size distribution of the reclaimed rubber will be described later.

From the viewpoint of recycling, the reclaimed rubber-containing rubber composition according to the present invention preferably contains as much of the reclaimed rubber as possible. However, from the viewpoint of improving the rupture strength of vulcanized rubber of the reclaimed rubber-containing rubber composition, the reclaimed rubber-containing rubber composition preferably contains 1 to 10 parts by mass of the reclaimed rubber when the total amount of a rubber component is taken as 100 parts by mass.

The reclaimed rubber-containing rubber composition according to the present invention may appropriately contain, in addition to the reclaimed rubber, a compounding agent usually used in the rubber industry, such as an unvulcanized rubber (new rubber), a filler, sulfur, a vulcanization accelerator, a silane coupling agent, zinc oxide, stearic acid, a vulcanization retarder, an organic peroxide, anantiaging agent, a softening agent such as wax or oil, or a processing aid.

The rubber component (unvulcanized rubber (new rubber)) is preferably a diene-based rubber, and examples thereof include natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These butadiene-based rubbers may be used singly or in combination of two or more of them. The diene-based rubber is preferably natural rubber, butadiene rubber, styrene-butadiene rubber, or a blend of two or more of them.

The reclaimed rubber-containing rubber composition according to the present invention preferably contains carbon black as a filler. Examples of the carbon black that can be used include carbon blacks usually used in the rubber industry, such as SAF, ISAF, HAF, FEF, and GPF; and conductive carbon blacks such as acetylene black and ketjen black. The amount of the carbon black contained in the reclaimed rubber-containing rubber composition according to the present invention is preferably 0 to 70 parts by mass, more preferably 30 to 70 parts by mass when the total amount of the rubber component other than the reclaimed rubber is taken as 100 parts by mass.

The reclaimed rubber-containing rubber composition according to the present invention may contain silica as a filler. Examples of the silica to be used include silicas usually used for rubber reinforcement, such as wet silica, dry silica, sol-gel silica, and surface-treated silica. Among these, wet silica is preferred.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

The sulfur may be ordinary sulfur for rubber, and sulfur such as powdered sulfur, precipitated sulfur, insoluble sulfur, or highly dispersible sulfur can be used. The amount of the sulfur contained in the reclaimed rubber-containing rubber composition according to the present invention is preferably 0.5 to 5 parts by mass when the total amount of the rubber component other than the reclaimed rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

A method for blending the reclaimed rubber and the above-described components to obtain the reclaimed rubber-containing rubber composition according to the present invention is not limited, and any one of the following methods may be used: a method in which components to be blended other than vulcanization-type components such as sulfur and a vulcanization accelerator are previously kneaded to prepare a master batch, the remaining component (s) is (are) added to the master batch, and a resultant is further kneaded, a method in which components are added in any order and kneaded, and a method in which all the components are added at the same time and kneaded.

The reclaimed rubber-containing rubber composition according to the present invention is capable of providing a vulcanized rubber excellent in fracture characteristics and fatigue resistance. Therefore, the reclaimed rubber-containing rubber composition is useful as a rubber composition for pneumatic tires, especially a rubber composition for pneumatic tire treads.

### EXAMPLES

The present invention will more specifically be described below with reference to examples.

### (Production Examples of Reclaimed Rubber)

Tire tread members of truck and bus tires were buffed away and micronized to obtain particles having a maximum diameter of 500 μm using a cracker roll. Further, the particles were subjected to an air classifier to produce a rubber powder containing micronized particles having a maximum diameter of 150 μm. By micronizing the obtained rubber powder, the specific surface area of the rubber powder is increased so that a devulcanization effect is enhanced. Each of the micronized rubber powders was charged into an autoclave, a reclaiming agent was added, and a devulcanization reaction was performed (oil pan processing) at a temperature of about 200° C. for 3 to 6 hours in a steam atmosphere. In this way, reclaimed rubbers A and B were produced. Further, a commercially-available reclaimed rubber C (manufactured by Asahi Saiseigomu K.K., trade name “High-strength reclaimed rubber”), a commercially-available reclaimed rubber D (manufactured by Muraoka Rubber Reclaiming Co., Ltd., trade name “Tire reclaimed rubber (white line)”, and a reclaimed rubber E (rubber powder obtained by pulverizing TB tread members using a cracker roll and classifying a pulverized rubber powder by air classification) were prepared. The ratio between polymers constituting each of the reclaimed rubbers is shown in Table 1. In Table 1, “NR” stands for natural rubber, and “BR” stands for butadiene rubber. Further, the average particle diameters (d50, d70, and d90) of each of the reclaimed rubbers are shown in Table 1. Measurement methods will be described below.

<Rubber Elastic Modulus of Vulcanized Rubber of Rubber Composition for Evaluation as Measured with Atomic Force Microscope>

A rubber composition for evaluation (2) (reclaimed rubber-containing composition) containing, as a reclaimed rubber, 20 parts by mass of each of the reclaimed rubbers A to E per 100 parts by mass of isoprene rubber was prepared to have the above-described formulation of the rubber composition for evaluation (2), and an AFM elastic modulus image was observed. The rubber composition for evaluation (2) contains no filler because when carbon black is contained, an increase or decrease in elastic modulus image caused by adding the reclaimed rubber is hard to understand. The average elastic modulus of a matrix area was calculated. The average elastic modulus of matrix area of each of the reclaimed rubber-containing compositions is shown in Table 1.

<Average Particle Diameters (d50, d70, and d90) of Each of Reclaimed Rubbers>

The particle size distribution of each of the rubber powders was measured using SALD2300 manufactured by SHIMADZU CORPORATION. A laser diffraction/scattering method is a method in which a group of particles is irradiated with laser light and a particle size distribution is determined by calculation from the intensity distribution pattern of diffracted/scattered light emitted therefrom. When a particle is irradiated with a laser beam, light is emitted from the particle in various directions such as forward/backward, up/down, and left/right. This is light called “diffracted/scattered light”. The intensity of diffracted/scattered light forms a certain spatial pattern in a direction that the light is emitted. This is the “light intensity distribution pattern”. The “light intensity distribution pattern” is known to change to various shapes depending on the particle size. The average particle diameters (d50, d70, and d90) of each of the reclaimed rubbers were measured by detecting the light intensity distribution pattern.

TABLE 1

| | | Type of reclaimed rubber | | | | | |
|---|---|---|---|---|---|---|---|
| | | Reclaimed | Reclaimed | Reclaimed | Reclaimed | Reclaimed | Reclaimed |
| | | rubber A | rubber B | rubber C | rubber D | rubber E | rubber-free |
| Ratio between | | NR79/BR21 | NR90/BR10 | NR80/BR20 | NR60/BR40 | NR80/BR20 | — |
| polymers (%) | | | | | | | |
| Average | d50 | 73 | 76 | 220 | 226 | 220 | — |
| particle | d70 | 97 | 98 | 260 | 268 | 260 | — |
| diameter of | d90 | 136 | 138 | 380 | 390 | 380 | — |
| reclaimed | | | | | | | |
| rubber | | | | | | | |

| | | | | | | |
|---|---|---|---|---|---|---|
| Rubber elastic | 2.6 | 2.5 | 2.3 | 1.6 | 1.2 | 0.9 |
| modulus (MPa) of | | | | | | |
| vulcanized rubber | | | | | | |
| of rubber | | | | | | |
| composition for | | | | | | |
| evaluation as | | | | | | |
| measured with | | | | | | |
| atomic force | | | | | | |
| microscope | | | | | | |

As can be seen from the results shown in Table 1, in the case of the rubber composition for evaluation (2) containing no reclaimed rubber (shown as “reclaimed rubber-free” in Table 1), the rubber elastic modulus of the vulcanized rubber was as low as 0.9, but the rubber elastic modulus was 2.0 MPa or more when each of the reclaimed rubbers A to C was contained, and particularly the rubber elastic modulus was 2.5 MPa or more when the reclaimed rubber A or B was contained.

### (Preparation of Reclaimed Rubber-Containing Rubber Compositions)

Components were blended with 100 parts by mass of a rubber component (natural rubber) excluding a reclaimed rubber according to a formulation shown in Tables 2 to 4 and kneaded using a Labo mixer manufactured by DAIHAN CO., LTD. In this way, reclaimed rubber-containing rubber compositions according to Examples 1 to 3 and Comparative Examples 1 and 2 were produced. It should be noted that, for example, Example 1-(1) is a reclaimed rubber-containing rubber composition containing the reclaimed rubber A, which contains 1 part by mass of the reclaimed rubber A per 100 parts by mass of the rubber component (natural rubber), and for example, Comparative Example 1-(5) is a reclaimed rubber-containing rubber composition containing the reclaimed rubber D, which contains 5 parts by mass of the reclaimed rubber D per 100 parts by mass of the rubber component (natural rubber).

The details of the components listed in Tables 2 to 4 are as follows.
Natural rubber: STR20
Carbon black(HAF): “Seast 3” manufactured by TOKAI CARBON CO., LTD.
Stearic acid: “LUNAC S-20” manufactured by Kao Corporation
Zinc white: “Zinc White #1” manufactured by Mitsui Mining & Smelting Corporation
Sulfur: “Powdered sulfur for rubber, 150 mesh” manufactured by Hosoi Chemical Industry Co., Ltd.
Vulcanization accelerator: “NOCCELER NS” manufactured by Ouchi Shinko Chemical Industrial Co., Ltd.

Then, the obtained reclaimed rubber-containing rubber compositions were vulcanized at 150° C. for 25 minutes to produce test pieces having a predetermined shape, and the following tests were performed using the obtained test pieces.

### <Rupture Strength>

The rupture strength (MPa) of the sample prepared using a JIS No. 3 dumbbell was measured in accordance with JIS K6251. In Tables 2 to 4, the rupture strength is expressed as an index number determined by taking the values of rupture strength of Comparative Example 1-(1), Comparative Example 1-(3), and Comparative Example 1-(5) respectively containing 1, 3, and 5 parts by mass of the reclaimed rubber D per 100 parts by mass of the rubber component (natural rubber) as 100. A larger index number indicates that the rupture strength is higher, and therefore the reclaimed rubber-containing rubber composition is capable of providing a vulcanized rubber more excellent in fracture characteristics.

### <Elongation at Break>

The elongation at break (%) of the sample prepared using a JIS No. 3 dumbbell was measured in accordance with JIS K6251. In Tables 2 to 4, the elongation at break is expressed as an index number determined by taking the values of elongation at break of Comparative Example 1-(1), Comparative Example 1-(3), and Comparative Example 1-(5) respectively containing 1, 3, and 5 parts by mass of the reclaimed rubber D per 100 parts by mass of the rubber component (natural rubber) as 100. A larger index number indicates that the elongation at break is higher, and therefore the reclaimed rubber-containing rubber composition is capable of providing a vulcanized rubber more excellent in fracture characteristics.

### <Fatigue Resistance>

In accordance with JIS K6260, the vulcanized rubber was repeatedly elongated (constant strain was repeatedly applied to the vulcanized rubber) using a De Mattia tester to count the number of elongation cycles before breakage (occurrence of cracking) to measure fatigue resistance (flex cracking resistance). In Tables 2 to 4, the fatigue resistance is expressed as an index number determined by taking the numbers of elongation cycles before breakage (occurrence of cracking) of Comparative Example 1-(1), Comparative Example 1-(3), and Comparative Example 1-(5) respectively containing 1, 3, and 5 parts by mass of the reclaimed rubber D per 100 parts by mass of the rubber component (natural rubber) as 100. A larger index number indicates that the number of elongation cycles before breakage (occurrence of cracking) is larger, and therefore the reclaimed rubber-containing rubber composition is capable of providing a vulcanized rubber more excellent in fatigue resistance.

TABLE 2

| Example | Example | Example | Comparative Example | Comparative Example |
|---|---|---|---|---|
| 1-(1) | 2-(1) | 3-(1) | 1-(1) | 2-(1) |

(Formulation)

| | | | | | |
|---|---|---|---|---|---|
| Natural rubber | 100 | 100 | 100 | 100 | 100 |
| Carbon black | 50 | 50 | 50 | 50 | 50 |
| Reclaimed rubber A | 1 | | | | |
| Reclaimed rubber B | | 1 | | | |
| Reclaimed rubber C | | | 1 | | |
| Reclaimed rubber D | | | | 1 | |
| Reclaimed rubber E | | | | | 1 |
| Stearic acid | 2 | 2 | 2 | 2 | 2 |
| Zinc white | 2 | 2 | 2 | 2 | 2 |
| Vulcanization | 1.5 | 1.5 | 1.5 | 1.5 | 1.5 |
| accelerator | | | | | |
| Sulfur | 1.5 | 1.5 | 1.5 | 1.5 | 1.5 |

(Evaluations)

| | | | | | |
|---|---|---|---|---|---|
| Rupture strength | 103 | 103 | 101 | 100 | 98 |
| Elongation at break | 101 | 101 | 100 | 100 | 96 |
| Fatigue resistance | 102 | 102 | 101 | 100 | 96 |

As can be seen from the results shown in Table 2, the vulcanized rubbers of the reclaimed rubber-containing rubber compositions according to Example 1-(1) to Example 3-(1) have high rupture strength and elongation at break and are therefore excellent in fracture characteristics, and are excellent also in fatigue resistance. Particularly, it can be seen that the vulcanized rubbers of the reclaimed rubber-containing rubber compositions according to Example 1-(1) to Example 2-(1) containing the reclaimed rubber that allows a vulcanized rubber of the rubber composition for evaluation to have a rubber elastic modulus of 2.5 MPa or more as measured by scanning a matrix area with an atomic force microscope have higher rupture strength and elongation at break and are therefore more excellent in fracture characteristics, and are more excellent also in fatigue resistance.

TABLE 3

| Example | Example | Example | Comparative Example | Comparative Example |
|---|---|---|---|---|
| 1-(3) | 2-(3) | 3-(3) | 1-(3) | 2-(3) |

(Formulation)

| | | | | | |
|---|---|---|---|---|---|
| Natural rubber | 100 | 100 | 100 | 100 | 100 |
| Carbon black | 50 | 50 | 50 | 50 | 50 |
| Reclaimed rubber A | 3 | | | | |
| Reclaimed rubber B | | 3 | | | |
| Reclaimed rubber C | | | 3 | | |
| Reclaimed rubber D | | | | 3 | |
| Reclaimed rubber E | | | | | 3 |
| Stearic acid | 2 | 2 | 2 | 2 | 2 |
| Zinc white | 2 | 2 | 2 | 2 | 2 |
| Vulcanization | 1.5 | 1.5 | 1.5 | 1.5 | 1.5 |
| accelerator | | | | | |
| Sulfur | 1.5 | 1.5 | 1.5 | 1.5 | 1.5 |

(Evaluations)

| | | | | | |
|---|---|---|---|---|---|
| Rupture strength | 105 | 105 | 102 | 100 | 99 |
| Elongation at break | 103 | 102 | 100 | 100 | 96 |
| Fatigue resistance | 104 | 103 | 102 | 100 | 97 |

As can be seen from the results shown in Table 3, the vulcanized rubbers of the reclaimed rubber-containing rubber compositions according to Example 1-(3) to Example 3-(3) have high rupture strength and elongation at break and are therefore excellent in fracture characteristics, and are excellent also in fatigue resistance. Particularly, it can be seen that the vulcanized rubbers of the reclaimed rubber-containing rubber compositions according to Example 1-(3) to Example 2-(3) containing the reclaimed rubber that allows a vulcanized rubber of the rubber composition for evaluation to have a rubber elastic modulus of 2.5 MPa or more as measured by scanning a matrix area with an atomic force microscope have higher rupture strength and elongation at break and are therefore more excellent in fracture characteristics, and are more excellent also in fatigue resistance.

TABLE 4

| Example | Example | Example | Comparative Example | Comparative Example |
|---|---|---|---|---|
| 1-(5) | 2-(5) | 3-(5) | 1-(5) | 2-(5) |

(Formulation)

| | | | | | |
|---|---|---|---|---|---|
| Natural rubber | 100 | 100 | 100 | 100 | 100 |
| Carbon black | 50 | 50 | 50 | 50 | 50 |
| Reclaimed rubber A | 5 | | | | |
| Reclaimed rubber B | | 5 | | | |
| Reclaimed rubber C | | | 5 | | |
| Reclaimed rubber D | | | | 5 | |
| Reclaimed rubber E | | | | | 5 |
| Stearic acid | 2 | 2 | 2 | 2 | 2 |
| Zinc white | 2 | 2 | 2 | 2 | 2 |
| Vulcanization | 1.5 | 1.5 | 1.5 | 1.5 | 1.5 |
| accelerator | | | | | |
| Sulfur | 1.5 | 1.5 | 1.5 | 1.5 | 1.5 |

(Evaluations)

| | | | | | |
|---|---|---|---|---|---|
| Rupture strength | 108 | 106 | 105 | 100 | 97 |
| Elongation at break | 105 | 104 | 100 | 100 | 93 |
| Fatigue resistance | 108 | 105 | 102 | 100 | 89 |

As can be seen from the results shown in Table 4, the vulcanized rubbers of the reclaimed rubber-containing rubber compositions according to Example 1-(5) to Example 3-(5) have high rupture strength and elongation at break and are therefore excellent in fracture characteristics, and are more excellent also in fatigue resistance. Particularly, it can be seen that the vulcanized rubbers of the reclaimed rubber-containing rubber compositions according to Example 1-(5) to Example 2-(5) containing the reclaimed rubber that allows a vulcanized rubber of the rubber composition for evaluation to have a rubber elastic modulus of 2.5 MPa or more as measured by scanning a matrix area with an atomic force microscope have higher rupture strength and elongation at break and are therefore more excellent in fracture characteristics, and are more excellent also in fatigue resistance.

What is claimed is:

1. A reclaimed rubber-containing rubber composition comprising a reclaimed rubber,
wherein the reclaimed rubber allows a vulcanized rubber of a specific rubber composition for evaluation described below to have a rubber elastic modulus of 2.0 MPa or more as measured with an atomic force microscope:
rubber composition for evaluation; a rubber composition containing 20 parts by mass of the reclaimed rubber per 100 parts by mass of isoprene rubber and not containing carbon black.

2. The reclaimed rubber-containing rubber composition according to claim 1, wherein the rubber composition for evaluation contains 1.5 parts by mass of sulfur per 100 parts by mass of isoprene rubber.

3. The reclaimed rubber-containing rubber composition according to claim 1, which contains 1 to 10 parts by mass of the reclaimed rubber when a total amount of a rubber component is taken as 100 parts by mass.

4. The reclaimed rubber-containing rubber composition according to claim 1, wherein the reclaimed rubber is derived from a tire tread.

5. The reclaimed rubber-containing rubber composition according to claim 1, wherein the reclaimed rubber contains 50 parts by mass or more of at least one selected from the group consisting of natural rubber and isoprene rubber when a total amount of a rubber component is taken as 100 parts by mass.

6. A pneumatic tire comprising a rubber part obtained by vulcanizing and molding the reclaimed rubber-containing rubber composition according to claim 1.
